(19) United States
(12) Patent Application Publication
(10) Pub. No.: US 2021/0230405 A1
(43) Pub. Date: Jul. 29, 2021

(54) THERMALLY EXPANDABLE RUBBER COMPOSITION

(71) Applicant: SIKA TECHNOLOGY AG, Baar (CH)

(72) Inventors: Cornelia BÖFER, Effretikon (CH); Michael GUTGSELL, Uster (CH)

(73) Assignee: SIKA TECHNOLOGY AG, Baar (CH)

(21) Appl. No.: 17/263,992

(22) PCT Filed: Sep. 2, 2019
(86) PCT No.: PCT/EP2019/073304

§ 371 Date: Jan. 28, 2021

(30) Foreign Application Priority Data
Sep. 3, 2018 (EP) 18192304.6

(51) Int. Cl. C08L 9/06; C09J 109/06

(52) U.S. Cl. CPC C08L 9/06; C09J 109/06

(57) ABSTRACT

A thermally expandable rubber composition, including a) at least one solid rubber A from the group made of styrene-butadiene rubber, cis-1,4-polybutadiene, synthetic isoprene rubber, natural rubber, ethylene-propylene-diene rubber (EPDM), nitrile rubber, butyl rubber and acrylic rubber; b) processing oil PO, comprising at least one Treated Distillate Aromatic Extract (TDAE); c) at least one vulcanization system VS; d) at least one filler G; e) at least one blowing agent BA selected from the list of bicarbonate, polycarboxylic acids and salts of polycarboxylic acids. The thermally expandable rubber composition provides good adhesion on metal substrates after curing at curing-temperatures around 160° C.

### TECHNICAL FIELD

The present invention relates to a thermally expandable rubber composition, comprising at least a solid rubber A, a processing oil PO, a vulcanization system VS, a filler G and a blowing agent BA as well as a method of bonding substrates, especially to obtain good adhesion at curing temperatures around 160° C.

### BACKGROUND OF THE INVENTION

Manufactured products often contain hollow parts that result from the manufacturing process and/or that are designed into the product for various purposes, such as weight reduction. Automotive vehicles, for example, include several such hollow parts throughout the vehicle, including in the vehicle's roof, engine hood, trunk hood and in vehicle doors. It is often desirable to connect/bond the parts/substrates forming the hollow parts additionally at least at certain places so as to minimise vibrations and noise through such vibrations caused upon movement of the vehicle.

A suitable rubber composition to connect these parts/substrates for vibration reduction is able to expand its volume when heat is applied in order to increase its flexibility and to reduce alterations of the surface on the bonded parts also called “read-through” for aesthetic reasons.

For example, during the manufacture process of a vehicle, the hollow parts of a vehicle's roof can contain applied beads of an uncured rubber composition between roof beam and the roof layer and can still be largely covered by an electro-coating liquid while applied beads of an uncured rubber composition between upper and the lower roof layer are already inserted, and afterwards during a heat treatment step, the expandable rubber composition expands and firmly connects the two layers in order to minimise vibrations and noise through such vibrations caused upon movement of the vehicle.

When cuing temperatures between 150-160° C. are present during the manufacturing process, the adhesion on substrates, especially metal substrates, is difficult to obtain. Such lower curing temperature can occur for example at locations within the part to be cured that are somehow more difficult to bring to the normal curing temperature of around 180° C. due to the locations limited accessibility.

It is thus desirable to obtain a thermally expandable rubber composition that provides good adhesion on substrates, especially metal substrates, after curing at temperatures between 150-160° C., especially 160° C.

### SUMMARY OF THE INVENTION

It is an object of the present invention to provide a thermally expandable rubber composition that provides good adhesion on substrates, especially metal substrates, after curing at temperatures between 150-160° C., especially 160° C.

Surprisingly, the present invention provides a solution to that problem by providing a rubber composition, comprising
a) at least one solid rubber A from the group consisting of styrene-butadiene rubber, cis-1,4-polybutadiene, synthetic isoprene rubber, natural rubber, ethylene-propylene-diene rubber (EPDM), nitrile rubber, butyl rubber and acrylic rubber;
b) processing oil PO, comprising at least one Treated Distillate Aromatic Extract (TDAE);
c) at least one vulcanization system VS;
d) at least one filler G;
e) at least one blowing agent BA selected from the list of bicarbonate, polycarboxylic acids and salts of polycarboxylic acids.

The composition according to the present invention is particularly suitable to be used in sound dampening/vibration reduction, for example in automotive applications. Further aspects of the present invention are subject of other independent claims. Preferred embodiments of the invention are subject of dependent claims.

### DETAILED DESCRIPTION OF THE INVENTION

The unit term “wt.-%” means percentage by weight, based on the weight of the respective total composition, if not otherwise specified. The terms “weight” and “mass” are used interchangeably throughout this document.

Volume changes on the thermally expandable material are determined using the DIN EN ISO 1183 method of density measurement (Archimedes principle) in deionised water in combination with sample mass determined by a precision balance.

The present invention comprises a) at least one solid rubber A from the group consisting of styrene-butadiene rubber, cis-1,4-polybutadiene, synthetic isoprene rubber, natural rubber, ethylene-propylene-diene rubber (EPDM), nitrile rubber, butyl rubber and acrylic rubber.

Preferred solid rubbers have a molecular weight of 100'000 or more.

Preferably the at least one solid rubber A contains a styrene-butadiene rubber A1. Preferably, the styrene-butadiene rubber A1 is an emulsion-polymerized SBR rubber. These can be divided into two types, cold rubber and hot rubber depending on the emulsion polymerization temperature, but hot rubbers (hot type) are preferred.

Preferably, the styrene-butadiene rubber A1 has a styrene content of from 1 to 60% by weight, preferably from 2 to 50% by weight, from 10 to 40% by weight, from 20 to 40% by weight, most preferred 20 to 30% by weight.

Particularly preferred pre-crosslinked styrene-butadiene elastomer are Petroflex™ SBR 1009A, 1009S and 1018 elastomers, manufactured by Petroflex, Brasil, using either rosin or fatty acids soaps as emulsifier and coagulated by the salt-acid method, and SBR 1009, 1009A and 4503 elastomers, manufactured by ISP Corporation, Texas, USA, by hot emulsion polymerization with divinylbenzene.

Preferred styrene-butadiene rubber A1 have a Mooney viscosity (ML 1+4 at 100° C.) of 40-150 MU (Mooney units), preferably 40-100 MU, 55-80 MU.

Preferably, Mooney viscosity refers to the viscosity measure of rubbers. It is defined as the shearing torque resisting rotation of a cylindrical metal disk (or rotor) embedded in rubber within a cylindrical cavity. The dimensions of the shearing disk viscometer, test temperatures, and procedures for determining Mooney viscosity are defined in ASTM D1646.

Preferably the at least one solid rubber A contains a cis-1,4-polybutadiene A2.

Preferred cis-1,4-polybutadiene A2 have a cis-1,4-content greater than 90% by weight, preferably greater than 95% by weight.

Preferred cis-1,4-polybutadiene A2 have a Mooney viscosity (ML 1+4 at 100° C.) of 20-80 MU (Mooney units), preferably 20-60 MU, 30-50 MU.

Preferably, Mooney viscosity refers to the viscosity measure of rubbers. It is defined as the shearing torque resisting rotation of a cylindrical metal disk (or rotor) embedded in rubber within a cylindrical cavity. The dimensions of the shearing disk viscometer, test temperatures, and procedures for determining Mooney viscosity are defined in ASTM D1646.

It is especially preferred if the least one solid rubber A is selected from styrene-butadiene rubber A1 and cis-1,4-polybutadiene A2.

It is especially preferred if the least one solid rubber A contains both styrene-butadiene rubber A1 and cis-1,4-polybutadiene A2.

Preferably, the weight ratio between styrene-butadiene rubber A1 and cis-1,4-polybutadiene A2 is from 4:1-1:2, preferably from 3:1-1:1, most preferably from 2.5:1-1.5:1.

Preferably, the the total amount of the at least one solid rubber A is between 5 and 30 wt-%, preferably between 7.5 and 25 wt-%, 7.5 and 20 wt-%, 7.5 and 15 wt-%, most preferred between 7.5 and 12.5 wt-%, based on the total weight of the rubber composition. This is advantageous for the miscibility and processability of the rubber composition.

The present invention comprises b) processing oil PO, comprising at least one Treated Distillate Aromatic Extract (TDAE). This specific kind of aromatic oil is obtained from crude oil for example by vacuum extraction, followed by solvent extraction and a second extraction step.

It was surprisingly found that such processing oil PO are advantageous for good adhesion on metal substrates, especially oiled metal substrates, in combination with at least one blowing agent BA selected from the list of bicarbonate, polycarboxylic acids and salts of polycarboxylic acids at curing temperatures of 160° C. This is for example seen in table 2 and table 3 by the comparison of E4-E8 with E12-E16.

The compositions of E4-E8 contain a mixture of a naphthenic and a paraffinic oil and lead to a 100% adhesive failure in combination with the mentioned blowing agent BA. On the other hand cohesive failure was obtained for the examples E12-E16 containing a processing oil PO comprising at least one Treated Distillate Aromatic Extract (TDAE).

These TDAE preferably have a content of polycyclic aromatic compounds (PCA) of 3 wt.-% or less, preferably 2.8 wt.-% or less, more preferably 2.6 wt.-% or less, measured according to IP (The Institute of Petroleum) 346 method (PCA standard test).

It is further preferred if the TDAE contains between 20-30 wt.-% of aromatic carbon atoms (Carbon Structure X(A)), 25-35 wt.-% of naphthenic carbon atoms (Carbon Structure X(N)), 40-50 wt.-% of paraffinic carbon atoms (Carbon Structure X(P)), determined by the method DIN 51378.

It is further preferred if the TDAE has a kinematic viscosity at 40° C. of 200-600 mm²/s, measured according to DIN 51562 T. 1.

It is further preferred if the TDAE has a content of aromatic substances, according to ASTM D 2007, of 50-70 wt.-%, preferably 55-65 wt.-%.

It is further preferred if the processing oil PO consists of more than 50 wt.-%, 60 wt.-%, 80 wt.-%, more than 90 wt.-%, preferably 95 wt.-%, most preferably more than 99 wt.-% of TDAE, based on the total amount of processing oil PO.

Preferably, the total amount of the processing oil PO is between 20 and 50 wt-%, preferably between 20 and 40 wt-%, most preferably between 25 and 35 wt-%, based on the total weight of the rubber composition.

Preferably the weight ratio between the processing oil PO and the solid rubber A (PO/A) is from 1-10, 1.5-8, 1.5-6, 1.5-4, preferably from 2-3.

The rubber composition comprises c) at least one vulcanization system VS.

A large number of vulcanization systems based on elementary sulfur as well as vulcanization systems not containing elementary sulfur are suitable.

If a vulcanization systems based on elementary sulfur is used, a system containing pulverulent sulfur is preferred. Such a vulcanization system preferably consists of 1 wt. % to 15 wt. %, preferably 5 wt. % to 10 wt. %, of pulverulent sulfur.

Preferably, vulcanization systems without elementary sulfur compounds are used.

These vulcanization systems without elementary sulfur include vulcanization systems based on organic peroxides, polyfunctional amines, quinones, p-benzoquinone dioxime, p-nitrosobenzene and dinitrosobenzene, as well as vulcanization systems crosslinked with (blocked) diisocyanates.

Preferably, these vulcanization systems with or without elementary sulfur can further comprise organic vulcanization accelerators as well as zinc compounds.

Organic vulcanization accelerators that are suitable include the dithiocarbamates (in the form of their ammonium or metal salts), xanthogenates, thiuram compounds (monosulfides and disulfides), thiazole compounds, aldehyde-amine accelerators (e.g. hexamethylenetetramine) as well as guanidine accelerators, most particularly preferred being dibenzothiazyl disulfide (M BTS).

These organic accelerators are used in amounts of between 0.5 and 3 wt. %, referred to the overall rubber composition.

Zinc compounds acting as vulcanization accelerators may be selected from zinc salts of fatty acids, zinc dithiocarbamates, basic zinc carbonates as well as, in particular particulate zinc oxide. The content of zinc compounds is preferably in the range between 0.5 and 3, 1 and 3, based on the overall rubber composition.

Preferably, the vulcanization system VS is a vulcanization system without elementary sulfur, preferably containing p-benzoquinone dioxime, that further comprises organic vulcanization accelerators, preferably dibenzothiazyl disulfide, as well as zinc compounds, preferably zinc oxide. Preferably such a vulcanization system is present in an amount of 1 and 8 wt.-%, preferably 2 and 7 wt.-%, more preferably 3 and 6 wt.-%, based on the weight of the overall rubber composition.

The rubber composition comprises d) at least one filler G.

Suitable as fillers are, e.g., ground or precipitated calcium carbonate, lime, calcium-magnesium carbonate, talcum, gypsum, graphite, barite, silica, silicates, mica, wollastonite, carbon black, or the mixtures thereof, or the like. Preferably the filler G is selected from ground calcium carbonat, precipitated calcium carbonate and lime.

Preferably, the total amount of the at least one filler G is between 30 and 60 wt-%, preferably between 35 and 55 wt-%, most preferably between 40 and 50 wt-%, based on the total weight of the rubber composition. In case the amount is more than 60 wt-% the viscosity might increase too much. An amount of less than 30 wt-% leads to a reduction in in sag resistance.

The rubber composition comprises e) at least one blowing agent BA selected from the list of bicarbonate, polycarboxylic acids and salts of polycarboxylic acids.

The bicarbonate is preferably a bicarbonate of the formula XHCO₃, wherein X may be any cation, in particular an alkali metal ion, preferably Na+ or K+ or NH₄, or a mixture of 2 or more bicarbonates. Most preferred is sodium bicarbonate.

The polycarboxylic acids are preferably selected from solid, organic di-, tri- or tetra acid, in particular hydroxy-functionalized or unsaturated di-, tri-, tetra or polycarboxylic acid. Preferably, the polycarboxylic acids are selected from the list consisting of citric acid, tartaric acid, malic acid, fumaric acid and maleic acid. Most preferred is citric acid.

Preferably, the blowing agent BA contains a mixture of bicarbonate and of polycarboxylic acids and/or salts thereof, more preferred a mixture of bicarbonate and of polycarboxylic acids, even more preferred a mixture of sodium bicarbonate and citric acid and/or citrate, most preferred a mixture of sodium bicarbonate and citric acid.

Such a mixture is advantageous for good adhesion on metal substrates, especially oiled metal substrates at curing temperatures of 160° C.

It is further preferred that the weight ratio of (polycarboxylic acids and/or salts thereof) to (bicarbonate) is from 0.05-15, 0.075-12.5, 0.5-12.5, 2-10, 3-8, preferably 4-7, most preferably 5-6.

Such a ratio is advantageous for good adhesion on metal substrates, especially oiled metal substrates at curing temperatures of 160° C. It was further surprisingly found that such a ratio decreases the read-through of the surface on the bonded substrates.

It is even more preferred that the weight ratio of (citric acid and/or citrate) to (sodium bicarbonate), more preferably that the weight ratio of (citric acid) to (sodium bicarbonate), is from 0.05-15, 0.075-12.5, 0.5-12.5, 2-10, 3-8, preferably 4-7, most preferably 5-6.

It is also preferred that the blowing agent BA has a maximum decomposition peak measured by Differential Scanning calorimetry (DSC) within 135-200° C., preferably within 150-200° C., within 160-200° C., more preferably within 170-200° C., most preferably between 175-195° C. Preferably, the maximum decomposition peak measured by DSC is determined by a DSC822e differential scanning calorimeter from Mettler-Toledo by keeping the sample for 2 min at 25° C., then heating the sample from 25° C. to 280° C. at a rate of 5° C./min, then keeping the sample for 2 min at 280° C. and finally cooling the sample from 280° C. to 25° C. at a rate of 10° C./min.

This is advantageous for good adhesion on metal substrates, especially oiled metal substrates at curing temperatures of 160° C. It is especially surprising that the composition E12 containing blowing agent BA-4 with a maximum decomposition peak of 140-145° C., hence a maximum decomposition peak lower than 160° C., has an inferior adhesion compared to composition E13 or E14, containing blowing agent BA-5, BA-6 respectively, with a maximum decomposition peak of 175-195° C.

It is further preferred that the weight ratio of solid rubber A to blowing agent BA (solid rubber A/blowing agent BA) is from 2-30, 5-25, 5-20, preferably 7-15, most preferably 8-12.5.

Known blowing agents in the state of the art may be a chemical or physical blowing agents. Chemical blowing agents are organic or inorganic compounds that decompose under influence of, e.g., temperature or humidity, while at least one of the formed decomposition products is a gas. Physical blowing agents include, but are not limited to, compounds that become gaseous at a certain temperature. Thus, both chemical and physical blowing agents are suitable to cause an expansion in thermally expandable compositions.

Preferably, the rubber composition contains less than 5 wt.-% of chemical or physical blowing agents other than the at least one blowing agent BA selected from the list of bicarbonate, polycarboxylic acids and salts of polycarboxylic acids, based on the total weight of the rubber composition. More preferably, the rubber composition contains less than 2 wt.-%, less than 1 wt.-%, less than 0.5 wt.-%, less than 0.1 wt.-%, less than 0.01 wt.-%, most preferably 0 wt.-%, of chemical or physical blowing agents other than the at least one blowing agent BA selected from the list of bicarbonate, polycarboxylic acids and salts of polycarboxylic acids, based on the total weight of the rubber composition.

Chemical blowing agents other than the at least one blowing agent BA selected from the list of bicarbonate, polycarboxylic acids and salts of polycarboxylic acids, include but are not limited to azo compounds, hydrazides, nitroso compounds, carbamates, and carbazides.

Physical blowing agents other than the at least one blowing agent BA selected from the list of bicarbonate, polycarboxylic acids and salts of polycarboxylic acids include expandable microspheres, consisting of a thermoplastic shell filled with thermally expandable fluids or gases. An example for such microspheres are Expancel® microspheres (by AkzoNobel).

Preferably, the blowing agent is included in the present inventive composition with an amount of between 0.1 and 2 wt.-%, 0.2 and 1.5 wt.-%, 0.3 and 1.5 wt.-%, preferably between 0.4 and 1.2 wt.-%, more preferably between 0.6 and 1.2 wt.-%, based on the total weight of the rubber composition.

Preferably the weight ratio between the sum of processing oil PO and the sum of the solid rubber A (PO/solid rubber A) is from 1.8-5.5, 2.3-5.5, 2.6-5.0, 3.0-4.5, preferably from 3.25-4.0, most preferably from 3.4-4.0. Such a ratio is advantageous for good expansion behaviour.

Apart from the essential ingredients, the present inventive rubber composition may contain other components commonly used in such compositions and known to the ordinarily skilled artisan in the field. These include, for example colorants, adhesion promoters, antioxidants and the like.

The rubber composition preferably has a viscosity of 30 to 4000 Pas at 25° C., preferably from 300 to 1000 Pas at 25° C.

The rubber composition preferably has a viscosity of 30 to 4000 Pas at 45° C., preferably from 200 to 800 Pas at 45° C., most preferably from 200 to 500 Pas at 45° C.

The viscosity is measured here by oscillographic means using a rheometer having a heatable plate (MCR 301, AntonPaar) (gap 1000 pm, measurement plate diameter: 25 mm (plate/plate), deformation 0.01% at 5 Hz, temperature: 25° C.).

The cured rubber composition preferably has a volume increase compared to the uncured composition of between 10-300%, preferably 20-200%, most preferred 40-70%. Preferably the volume increase is determined using the DIN EN ISO 1183 method of density measurement (Archimedes principle) in deionised water in combination with sample mass determined by a precision balance.

Preferably the values for volume increase (expansion) are determined as mentioned in the experimental section.

The compositions according to the present inventions can be manufactured by mixing the components in any suitable mixing apparatus, e.g. in a dispersion mixer, planetary mixer, double screw mixer, continuous mixer, extruder, or dual screw extruder.

Preferably, the at least one solid rubber A and the processing oil PO Are mixed in a separate step using a kneader, preferably a sigma blade kneader until a homogenous mixture is obtained. This homogenous mixture is then preferably mixed with the remaining components of the rubber composition in the suitable mixing apparatus mentioned above.

It may be advantageous to heat the components before or during mixing, either by applying external heat sources or by friction generated by the mixing process itself, in order to facilitate processing of the components into a homogeneous mixture by decreasing viscosities and/or melting of individual components. However, care has to be taken, e.g. by temperature monitoring and use of cooling devices where appropriate, not to exceed the activation temperatures of the blowing agent and/or vulcanization system VS.

A further aspect of the present invention relates to a method of bonding substrates, especially metal substrates, comprising the steps of

a) applying a rubber composition of the invention as defined above to a first substrate, especially a metal substrate, more preferably an oiled metal substrate;

b) contacting the rubber composition applied with a second substrate, especially a metal substrate, more preferably an oiled metal substrate; and

c) curing the rubber composition in the joined substrates at a temperature in the range from 150 to 180° C.

The first and/or second substrate, especially metal substrate, may each be used as such or as part of an article, i.e. of an article comprising the first or second substrate, especially metal substrate. Preferably, the substrates, especially metal substrates, more preferably oiled metal substrates, are used as such. The first and second substrates, especially metal substrates, may be made from the same or different materials.

The first and/or second substrates are preferably metal substrates. If appropriate, however, heat-resistant plastics, are also conceivable as first and/or second substrate.

Suitable first and/or second metal substrates are in principle all the metal substrates known to the person skilled in the art, especially in the form of a sheet, as utilized, for example, in the construction of modes of transport, for example in the automobile industry, or in the production of white goods. Preferably these metal substrates are oiled substrates meaning they are covered with corrosion protection oils known to the person skilled in the art. An example of such a corrosion protection oil is Anticorit PL 3802-39S.

Examples of the first and/or second metal substrate are metal substrates, especially sheets, of steel, especially electrolytically galvanized steel, hot-dip galvanized steel, bonazinc-coated steel, and subsequently phosphated steel, and also aluminium, especially in the variants that typically occur in automaking, and also magnesium or magnesium alloys. Preferably the substrates are oiled substrates.

The rubber composition is applied to the first substrate, especially metal substrate, in step (a) of the method of the invention. This is effected, for example, at an application temperature of the rubber composition of 10° C. to 80° C., preferably of 25° C. to 50° C., more preferably of 30 to 40° C. The application is preferably effected in the form of a bead. Automatic application is preferred.

The rubber composition can be applied over the entire surface or over part of the surface of the first substrate, especially metal substrate. In a typical application, the rubber composition can be applied, for example, only on a part, preferably less than 20%, less than 10%, less than 5%, preferably less than 2%, of the surface of the substrate facing the second substrate.

In a further step, the rubber composition applied to the first substrate, especially metal substrate, is contacted with the second substrate, especially metal substrate. After that the first and the second substrate can then preferably be further fixed by mechanical fixation, like spot welding or riveting, to prevent displacement of the joined substrates.

To cure the rubber composition in the joined substrates, the rubber composition is heated to a temperature in the range from 150 to 180° C., 150 to 170° C., preferably 150 to 160° C., most preferably 160° C. The heating can be effected, for example, by means of infrared radiation or induction heating or in an oven, for example a cathodic electrocoating oven. In this way, the substrates joined with the rubber composition is obtained.

Preferably the duration of said heating step is from 10-60 min, preferably 10-40 min, 10-30 min, most preferably 10-20 min.

The rubber composition in the joined substrates can be cured in one step, but curing in two or more steps is also possible, in which case intermediate operating steps between or during the curing steps are possible, for example a wash and/or a dip-coating operation, for example a cathodic electrocoating operation, of one or both substrates, especially metal substrates, with a subsequent wash.

The rubber composition of the invention and the method of the invention are especially suitable for bonding of substrates, especially metal substrates, for the manufacture of modes of transport, especially automobiles, buses, trucks, rail vehicles, ships or aircraft, or white goods, especially washing machines, tumble dryers or dishwashers, or parts thereof, preferably motor vehicles or installable components thereof.

Hence another aspect of the present invention is an article obtained from said method, especially a construction of modes of transport, especially in the automobile industry, or an article of white goods.

Hence another aspect of the present invention is the use of the rubber composition as described above for bonding and/or sealing, especially bonding, of substrates, especially metal substrates, for the manufacture of modes of transport, especially automobiles, buses, trucks, rail vehicles, ships or aircraft, or white goods, especially washing machines, tumble dryers or dishwashers, or parts thereof, especially to reduce vibrations and noised through such vibrations caused upon movement of the bonded substrates.

Hence another aspect of the present invention is the use of a blowing agent BA selected from the list of bicarbonate, polycarboxylic acids and salts of polycarboxylic acids as mentioned before for increasing the adhesion of a rubber composition on metal substrates, especially oiled metal substrates, after curing the rubber composition at a temperature in the range from 150 to 180° C., 150 to 170° C., preferably 150 to 160° C., most preferably 160° C.

Preferably the blowing agent BA has the preferred features and/or ratios as mentioned before. It is further preferred that the curing of the rubber composition was performed at mentioned temperature for 10-60 min, preferably 10-40 min, 10-30 min, most preferably 10-20 min.

The increase in adhesion is compared to a rubber composition mentioned above without the feature e) at least one blowing agent BA selected from the list of bicarbonate, polycarboxylic acids and salts of polycarboxylic acids. Preferably the adhesion increases in a way that the amount of cohesive failure judged by the fracture pattern after performing a tensile shear strength testing increases by more than 10%, preferably by more than 20%, most preferably by more than 50%. Preferably the tensile shear strength testing is performed according to (DIN EN 1465), more preferably as described in the experimental section. Preferably a fracture pattern with more than 20%, more than 50%, more than 75%, more than 80%, more preferably more than 90%, most preferably 100% of cohesive failure is obtained.

The invention is further explained in the following experimental part which, however, shall not be construed as limiting the scope of the invention.

### EXAMPLES

Chemicals Used for Formulating Rubber Compostions:

| Ingredient | Description |
|---|---|
| Solid rubber A1 | styrene-butadiene rubber, solid, Mooney viscosity 55-80 (ML |
| | 1 + 4 at 100° C., ASTM D1646), styrene content 20-30% |
| Solid rubber A2 | cis-1,4-polybutadiene, solid, Mooney viscosity 30-50 (ML 1 + 4 |
| | at 100° C., ASTM D1646), cis-1,4-content greater than 95% |
| Naphthenic | CAS: 64742-52-5, Distillates (petroleum) hydrotreated heavy |
| processing oil | naphthenic |
| Paraffinic | CAS No. 64742-65-0, Solvent-dewaxed heavy paraffinic |
| processing oil | distillate |
| TDAE | Vivatec 500, treated, distilled aromatic extract, Polycyclic |
| | aromatic hydrocarbons (PCA) content 2.6 wt.-% (IP 346), |
| | kinematic viscosity at 40° C. of 410 mm2/s (DIN 51562 T. 1), |
| | content of aromatic substances 61.7 wt.-% (ASTM D 2007), |
| | Hansen & Rosenthal KG (Germany) |
| CaCO₃, natural | natural ground calcium carbonate |
| CaCO₃, | precipitated calcium carbonate |
| precipitated | |
| Lime | Lime, ground |
| Vulcanisation | Mixture comprising p-benzoquinone dioxime, dibenzothiazyl |
| system | disulfide and zinc oxide in powder form. |
| B-Agent 1 | Blowing agent, microspheres, Advancell EMH 204, Sekisui |
| B-Agent 2 | Blowing agent, azodicarbonamide, Unicell DL75N |
| B-Agent 3 | Blowing agent, azodicarbonamide, Unicell D200A |
| B-Agent 4 | Blowing agent, |
| | CITRIC ACID 5 wt.-% |
| | NaHCO₃ 60 wt.-% |
| | maximum decomposition peak measured by DSC* 140-145° C. |
| B-Agent 5 | Blowing agent, |
| | CITRIC ACID 90 wt.-% |
| | NaHCO₃ 10 wt.-% |
| | maximum decomposition peak measured by DSC* 175-195° C. |
| B-Agent 6 | Blowing agent, |
| | CITRIC ACID 80 wt.-% |
| | NaHCO₃ 20 wt.-% |
| | maximum decomposition peak measured by DSC* 175-195° C. |

Table 1, *determined by DSC822e differential scanning calorimeter from Mettler-Toledo by keeping the sample for 2 min at 25° C., then heating the sample from 25° C. to 280° C. at a rate of 5° C./min, then keeping the sample for 2 min at 280° C. and finally cooling the sample from 280° C. to 25° C. at a rate of 10° C./min.

All inventive (E12-E16) and non-inventive (E1-E11) example compositions shown in table 2 were prepared according to the following procedure:

In a first step, the solid rubber A1 and solid rubber A2 were mixed in a sigma blade kneader for 15 min. After that, the processing oils were added constantly over a time of 5 hours. After this, the obtained mixture and all the remaining components were added into a speed mixture (total weight of the final composition approximately 300 g) and mixed during 3 min. The mixed rubber compositions were then stored in sealed cartridges.

TABLE 2

| Composition | | | | | | | | | | | | | | | | |
|---|---|---|---|---|---|---|---|---|---|---|---|---|---|---|---|---|
| Ingredient | E1 | E2 | E3 | E4 | E5 | E6 | E7 | E8 | E9 | E10 | E11 | E12 | E13 | E14 | E15 | E16 |
| Solid rubber A1 | 6.4 | 6.4 | 6.4 | 6.4 | 6.4 | 6.4 | 6.4 | 6.4 | 6.4 | 6.4 | 6.4 | 6.4 | 6.4 | 6.4 | 6.4 | 6.4 |
| Solid rubber A2 | 3.6 | 3.6 | 3.6 | 3.6 | 3.6 | 3.6 | 3.6 | 3.6 | 3.6 | 3.6 | 3.6 | 3.6 | 3.6 | 3.6 | 3.6 | 3.6 |
| Naphthenic | 18.8 | 18.8 | 18.8 | 18.8 | 18.8 | 18.8 | 18.8 | 18.8 | | | | | | | | |
| processing oil | | | | | | | | | | | | | | | | |
| Paraffinic | 18.8 | 18.8 | 18.8 | 18.8 | 18.8 | 18.8 | 18.8 | 18.8 | | | | | | | | |
| processing oil | | | | | | | | | | | | | | | | |
| TDAE | | | | | | | | | 37.6 | 37.6 | 37.6 | 37.6 | 37.6 | 37.6 | 37.6 | 37.6 |
| CaCO₃, natural | 33 | 33 | 33 | 33 | 33 | 33 | 33 | 33 | 33 | 33 | 33 | 33 | 33 | 33 | 33 | 33 |
| CaCO₃, | 10 | 10 | 10 | 10 | 10 | 10 | 10 | 10 | 10 | 10 | 10 | 10 | 10 | 10 | 10 | 10 |
| precipitated | | | | | | | | | | | | | | | | |
| Lime | 4 | 4 | 4 | 4 | 4 | 4 | 4 | 4 | 4 | 4 | 4 | 4 | 4 | 4 | 4 | 4 |
| Vulcanisation | 5 | 5 | 5 | 5 | 5 | 5 | 5 | 5 | 5 | 5 | 5 | 5 | 5 | 5 | 5 | 5 |
| system | | | | | | | | | | | | | | | | |
| B-Agent 1 | 1 | | | | | | | | 1 | | | | | | | |
| B-Agent 2 | | 0.4 | | | | | | | | 0.4 | | | | | | |
| B-Agent 3 | | | 0.4 | | | | | | | | 0.4 | | | | | |
| B-Agent 4 | | | | 1.2 | | | | | | | | 1.2 | | | | |
| B-Agent 5 | | | | | 0.8 | | 0.4 | 0.6 | | | | | 0.8 | | 0.4 | 0.6 |
| B-Agent 6 | | | | | | 0.8 | 0.4 | 0.6 | | | | | | 0.8 | 0.4 | 0.6 |
| Sum (weight-parts) | 100.6 | 100 | 100 | 100.8 | 100.4 | 100.4 | 100.4 | 100.8 | 100.6 | 100 | 100 | 100.8 | 100.4 | 100.4 | 100.4 | 100.8 |
| Ratio Citric acid/ | — | — | — | 0.08 | 9.0 | 4.0 | 5.7 | 5.7 | — | — | — | 0.08 | 9.0 | 4.0 | 5.7 | 5.7 |
| NaHCO₃ | | | | | | | | | | | | | | | | |
| Solid rubber/ | 10.0 | 25.0 | 25.0 | 8.3 | 12.5 | 12.5 | 12.5 | 8.3 | 10.0 | 25.0 | 25.0 | 8.3 | 12.5 | 12.5 | 12.5 | 8.3 |
| Blowing agent | | | | | | | | | | | | | | | | |

TABLE 3

| Composition | E1 | E2 | E3 | E4 | E5 | E6 | E7 | E8 |
|---|---|---|---|---|---|---|---|---|
| Adhesion (AF/CF) | 100/0 | 100/0 | 100/0 | 100/0 | 100/0 | 100/0 | 100/0 | 100/0 |
| Read-through | + | n.d. | n.d | n.d. | n.d. | n.d. | n.d. | n.d. |
| Composition | E9 | E10 | E11 | E12 | E13 | E14 | E15 | E16 |
| Adhesion (AF/CF) | 100/0 | 100/0 | 100/0 | 40/60 | 20/80 | 10/90 | 0/100 | 0/100 |
| Read-through | + | n.d | n.d | + | n.d. | n.d. | — | — |

n.d. = not determined

Adhesion on Metal Substrates

Tensile Shear Strength (TSS) (DIN EN 1465)

Cleaned and then oiled with Anticorit PL 3802-39S test specimens of steel (thickness 0.8 mm) were bonded with the compositions on an adhesive surface of 25×20 mm using teflon spacers in a layer thickness of 2.0 mm and cured.

Curing conditions: 15 min at 160° C. oven temperature.

The tensile shear strength was determined on a tensile machine at a tensile speed of 10 mm/min in a 3-fold determination according to DIN EN 1465.

The following visual assessment of the fracture appearance obtained from tensile shear strength test was used: The results were divided into CF (cohesive fracture) and AF (adhesive fracture) and the amount of the mentioned fracture was determined in % of the total fracture pattern.

Determination of Read-Through

The compositions were applied as a bead (50 mm length, 12 mm diameter) in the center of a test specimen (Rocholl “Lackprüfblech TC 01/C590” of steel (thickness 0.25 mm, 150×105 mm with white top coat). The bead was placed on the side adjacent to the side with the white top coat. The test specimen was then cured for 15 min at 160° C. oven temperature. After cooling to 25° C., the side of the specimen opposite to the cured bead was analyzed with a deflectometer.

The obtained curvature profile was then compared with the result obtained by using a bead consisting of the commercial products SikaSeal-710 LS (Sika Germany) and SikaPower 492 (Sika Germany).

SikaSeal-710 LS shows little read-through and was used as standard for little read-though. SikaPower 492 leads to significant read-through and was used as standard for high read-though. Compositions with a curvature profile closer to the one obtained with SikaPower 492 (more read-through) were labeled “+”.

Compositions with a curvature profile closer to the one obtained with SikaSeal-710 LS (less read-through) were labeled “−”.

The values for the adhesion (AF/CF) as well as the read-through are shown in table 3. The weight ratio of citric acid/NaHCO₃ is shown as “Ratio Citric acid/NaHCO₃”. The weight ratio of the sum of solid rubber A1 and A2/Blowing agent is shown as “Solid rubber/Blowing agent”.

1. A rubber composition, comprising
a) at least one solid rubber A from the group consisting of styrene-butadiene rubber, cis-1,4-polybutadiene, synthetic isoprene rubber, natural rubber, ethylene-propylene-diene rubber (EPDM), nitrile rubber, butyl rubber and acrylic rubber;
b) processing oil PO, comprising at least one Treated Distillate Aromatic Extract (TDAE);
c) at least one vulcanization system VS;
d) at least one filler G;
e) at least one blowing agent BA selected from the list of bicarbonate, polycarboxylic acids and salts of polycarboxylic acids.

2. The rubber composition according to claim 1, wherein the blowing agent BA contains a mixture of bicarbonate and of polycarboxylic acids and/or salts thereof.

3. The rubber composition according to claim 2, wherein the weight ratio of (polycarboxylic acids and/or salts thereof) to (bicarbonate) is from 0.05-15.

4. The rubber composition according to claim 1, wherein the blowing agent BA has a maximum decomposition peak measured by Differential Scanning calorimetry (DSC) within 135-200° C.

5. The rubber composition according to claim 1, wherein the weight ratio of solid rubber A to blowing agent BA is from 2-30.

6. The rubber composition according to claim 1, wherein the at least one solid rubber A is selected from styrene-butadiene rubber A1 and cis-1,4-polybutadiene A2.

7. The rubber composition according to claim 6, wherein the weight ratio between styrene-butadiene rubber A1 and cis-1,4-polybutadiene A2 is from 4:1-1:2.

8. The rubber composition according to claim 1, wherein the total amount of the at least one solid rubber A is between 5 and 30 wt-%, based on the total weight of the rubber composition.

9. The rubber composition according to claim 1, wherein the weight ratio between the sum of processing oil PO and the sum of the solid rubber A (PO/solid rubber A) is from 1.8-5.5.

10. The rubber composition according to claim 1, wherein the total amount of the processing oil PO is between 20 and 50 wt-%, based on the total weight of the rubber composition.

11. The rubber composition according to claim 1, wherein the at least one vulcanization system VS is a vulcanization system without elementary sulfur that further comprises organic vulcanization accelerators as well as zinc compounds.

12. A method of bonding substrates, comprising the steps of
a) applying a rubber composition according to claim 1 to a first substrate;
b) contacting the rubber composition applied with a second substrate; and
c) curing the rubber composition in the joined substrates at a temperature in the range from 150 to 180° C.

13. An article obtained from the method of claim 12, being a construction of modes of transport or an article of white goods.

14. A method comprising bonding and/or sealing with a rubber composition according to claim 11 for the manufacture of modes of transport or white goods.

15. A method comprising applying a blowing agent BA selected from the list of bicarbonate, polycarboxylic acids and salts of polycarboxylic acids for increasing the adhesion of a rubber composition on metal substrates after curing the rubber composition at a temperature in the range from 150 to 180° C.
